(19) United States
(12) Patent Application Publication
(10) Pub. No.: US 2022/0288648 A1
(43) Pub. Date: Sep. 15, 2022

(54) METHOD AND HYBRID DEVICE FOR CLEANING SURFACES

(71) Applicant: Airtouch Solar Ltd., Tel Aviv (IL)

(72) Inventor: Yanir ALLOUCHE, Tel Aviv (IL)

(73) Assignee: Airtouch Solar Ltd., Tel Aviv (IL)

(21) Appl. No.: 17/654,070

(22) Filed: Mar. 9, 2022

Related U.S. Application Data
(63) Continuation of application No. 63/158,732, filed on Mar. 9, 2021.

(51) Int. Cl. B08B 1/04; B08B 1/00; H02S 40/10

(52) U.S. Cl. CPC B08B 1/04; B08B 1/006; H02S 40/10

(57) ABSTRACT

A surface cleaning device that may include an axis; dust cleaning elements that are connected to the axis and comprise multiple fins that comprise (i) one or more first fins of a first durability and a first cleaning capability and (ii) one or more second fins of a second durability and a second cleaning capability, wherein the first durability exceeds the second durability and the second cleaning capability exceeds the first cleaning capability; and a rotating mechanism for rotating the axis and the multiple fins.

### FIELD OF THE INVENTION

The present disclosure relates to the field of surface cleaning devices.

### BACKGROUND OF THE INVENTION

Dust can be collected on surfaces of different kinds and can adversely affect operation of devices associated with the dust covered surfaces. One example of a surface that can be negatively affected by dust collection is a surface of a photovoltaic (“PV”) panel (also referred to as a solar panel).

There are various types of surface cleaning devices and multiple vendors of surface cleaning devices.

Example of robots for surface cleaning devices are illustrated in PCT patent application publication serial number WO2018/008033 international filing date 7 Jul. 2017 and PCT patent application publication serial number WO2019/155375 international filing date 6 Feb. 2019.

Some surface cleaning devices use microfiber fins as dust cleaning elements. The microfiber fins have an inner end that is fastened to a rotating rod and an external end that contacts (during a part of a rotation cycle) the solar panel.

The microfiber fins are elastic. When subjected to strong wind, the microfiber may be bent or otherwise deformed in a manner that may reduce the cleaning efficiency. For example—the outer end of the microfiber fin may not contact the solar panel when it should contact it.

There is a growing need to provide a surface cleaning device that will be more robust to winds.

There also a need in some places with more sticky soil/dirt, such bird drop or trees fruit, that require more deep cleaning to remove them out.

### SUMMARY

There may be provided a surface cleaning device for cleaning a surface of a solar panel and a method for operating the surface cleaning device.

There may be provided a surface cleaning device that may include (a) an axis; (b) dust cleaning elements that may be connected to the axis and may include multiple fins that may include (i) one or more first fins of a first durability and a first cleaning capability and (ii) one or more second fins of a second durability and a second cleaning capability, wherein the first durability exceeds (for example by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 200%, 310%, 320%, 330%, 340%, 350%, 360%, 370%, 380%, 390%, 400%, 500%, 600%, 700%, 800%, 900%, 1000% or more) the second durability and the second cleaning capability exceeds for example by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 200%, 310%, 320%, 330%, 340%, 350%, 360%, 370%, 380%, 390%, 400%, 500%, 600%, 700%, 800%, 900%, 1000% or more) the first cleaning capability; and (c) a rotating mechanism for rotating the axis and the multiple fins.

The one or more first fins may be one or more microfiber fins.

The one or more first fins may be one or more silicon foam fins.

The one or more first fins may be located at one or more first regions of the dust cleaning elements, and the one or more second fins may be located at one or more second regions of the dust cleaning elements.

The one or more first regions and the one or more second regions may not overlap.

The one or more first regions and the one or more second regions at least partially overlap.

The an aggregate size of the one or more first regions may exceed (or may be smaller than or may equal) an aggregate size of the one or more second regions.

The one or more second regions may be located below the one or more first regions.

The one or more second regions may be located at a bottom of the axis.

The one or more first fins may be of a first cost per first fin and the one or more second fins may be of a second cost per second fin that exceeds for example by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 200%, 310%, 320%, 330%, 340%, 350%, 360%, 370%, 380%, 390%, 400%, 500%, 600%, 700%, 800%, 900%, 1000% or more) the first cost.

The surface cleaning device may include one or more delay elements positioned in a path of the multiple fins.

The dust cleaning elements may include support elements that configured to reduce deformations of the multiple fins, wherein the support elements may be less elastic for example by at less than 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 200%, 310%, 320%, 330%, 340%, 350%, 360%, 370%, 380%, 390%, 400%, 500%, 600%, 700%, 800%, 900%, 1000% or less) than the multiple fins and may be positioned outside a reach of the one or more delay elements.

The surface cleaning device may include one or more shaking elements positioned in a path of the multiple fins.

The dust cleaning elements may include support elements that configured to reduce deformations of the multiple fins, wherein the support elements may be less elastic than the multiple fins and may be positioned outside a reach of the one or more shaking elements.

The dust cleaning elements may include support elements that configured to reduce deformations of the multiple fins, wherein the support elements may be less elastic than the multiple fins.

The support elements may be spaced apart from external edges of the multiple fins.

There may be provided a method for cleaning solar panels, the method may include rotating, by a rotating mechanism of a surface cleaning device, an axis and multiple fins of dust cleaning elements that may be connected to the axis, while moving the surface cleaning device along one or more areas of the solar panels; wherein the rotating of multiple fins contributes to a removal of dust from the one or more areas of the solar panels; wherein the multiple fins that may include (i) one or more first fins of a first durability and a first cleaning capability and (ii) one or more second fins of a second durability and a second cleaning capability, wherein the first durability exceeds the second durability and the second cleaning capability exceeds the first cleaning capability.

There may be provided a surface cleaning device that may include (a) an axis; (b) dust cleaning elements that may be connected to the axis and may include multiple fins and support elements that configured to reduce deformations of the multiple fins, wherein the support elements may be less elastic than the multiple fins; and (c) a rotating mechanism for rotating the axis and the dust cleaning elements.

The support elements may be spaced apart from external edges of the multiple fins.

There may be provided a method for cleaning solar panels, the method may include rotating, by a rotating mechanism of a surface cleaning device, an axis and dust cleaning elements that may be connected to the axis, while moving the surface cleaning device along one or more areas of the solar panels; wherein the dust cleaning elements may include multiple fins and support elements that configured to reduce deformations of the multiple fins; wherein the support elements may be less elastic than the multiple fins; and wherein the rotating contributes to a removal of dust from the one or more areas of the solar panels.

There may be provided a surface cleaning device that may include (a) an axis; (b) dust cleaning elements that may be connected to the axis and may include multiple fins and support elements that configured to reduce deformations of the multiple fins, wherein the support elements may be less elastic than the multiple fins; and (c) a rotating mechanism for rotating the axis and the dust cleaning elements. The multiple fins that may include (i) one or more first fins of a first durability and a first cleaning capability and (ii) one or more second fins of a second durability and a second cleaning capability, wherein the first durability exceeds the second durability and the second cleaning capability exceeds the first cleaning capability.

There may be provided a method for cleaning solar panels, the method may include rotating, by a rotating mechanism of a surface cleaning device, an axis and dust cleaning elements that may be connected to the axis, while moving the surface cleaning device along one or more areas of the solar panels; wherein the dust cleaning elements may include multiple fins and support elements that configured to reduce deformations of the multiple fins. The support elements may be less elastic than the multiple fins. The rotating contributes to a removal of dust from the one or more areas of the solar panels. The multiple fins that may include (i) one or more first fins of a first durability and a first cleaning capability and (ii) one or more second fins of a second durability and a second cleaning capability, wherein the first durability exceeds the second durability and the second cleaning capability exceeds the first cleaning capability.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of an example of a surface cleaning device;

FIG. 2 illustrates an example of an example of a surface cleaning device;

FIG. 3 illustrates an example of an example of a surface cleaning device;

FIG. 4 illustrates an example of an example of a surface cleaning device;

FIG. 5 illustrates an example of an example of a surface cleaning device;

FIG. 6 illustrates an example of an example of a surface cleaning device;

FIG. 7 illustrates an example of an example of a surface cleaning device;

FIG. 8 illustrates examples of multiple fins;

FIG. 9 illustrates an example of a method 200 for cleaning solar panels; and

FIG. 10 illustrates an example of a method 200 for cleaning solar panels.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system or device, unit, mechanism, circuit or apparatus capable of executing the method.

Any reference in the specification to a system, device, unit, mechanism, circuit or apparatus, should be applied mutatis mutandis to a method that may be executed by the system, device, unit, mechanism, circuit or apparatus.

The terms system, device, unit, mechanism, circuit, and apparatus are used in an interchangeable manner.

The terms rod, pipe and axis are used in an interchangeable manner.

Two directions are generally the same (or belong to the same general direction) when they are equal to each other or do not deviate from each other by more than ninety degrees.

The term “substantially”—unless stated otherwise may refer to a deviation of few percent (for example—deviation of less than 10% or less than 20 percent).

Any reference to a fin may be applied mutatis mutandis to a fin.

Any combination of any system, device, unit, mechanism, circuit, module or component listed in any of the figures, any part of the specification and/or any claims may be provided. Especially any combination of any claimed feature may be provided.

Any of the surface cleaning device referred to in the specification and/or drawings may perform dry cleaning—without using any fluid to clean the dust or substantially without using fluid to clean the dust. Substantially in this sense means that most of the cleaning process (for example—more than 80% or 90%) is performs by dry cleaning techniques.

A new material of Silicon foam with open cell or closed cell is found to be more effective for cleaning of more sticky dirt, thus can be jointly clean together with Microfibers fins to jointly remove soft and hard sticky dirt.

A combination of the two flexible material with or without the shaking element with multiple combination of materials of fins together can provide better cleaning performance.

The combinations that can be generate between those 2 material are either by one of the fins out of the 4,2,3 fins surrounding the axis will be of Silicon Foam material, alternatively in part of the axis (for example the down part) will use 1 or 2 fins of silicon foam together with 2 fins of microfiber for best cleaning one strip of the panel.

There may be provided a combination of microfiber together with flexible silicon foam open/and closed cell 0.1-0.6 g/CM3 density, with thickness of 2-8 mm. Any other values may be used.

There may be provided a surface cleaning device using partially non flexible part to allow carrying more air and bring the towels closer to the panels surface.

There may be provided a surface cleaning device that includes dust cleaning elements that include fins and support element connected to the fin or otherwise arranged to limit movement of at least a part of the fin.

The width of a fin (width measured along an axis that is parallel to the rotating axis) should exceed a few centimeter, may exceed a few tens of centimeters—it may have a width that is about the width of one or more solar panels, about a half of the width of the one or more solar panels, and the like.

The fins may be configured to move dust when contacting the dust during movement (and/or when static). The fin may absorb or aggregate dust or may not aggregate or absorb dust.

The fins (for example microfiber fins) have a certain elasticity. The support elements have a lower elasticity (in comparison to the certain elasticity of the fins)—thereby they reduce the bending and/or deformation of at least a part of the fins that are connected to the support element.

The support elements may be shaped and size not to reach the outer end of the fin—and to be distant enough from the outer end so as not to contact the solar panel.

The support elements may be shaped and sized not to contact any other element (not the solar panel) within the movement path of the fin. Such elements may be a delay element and/or a shaking element.

The support elements and/or the fins may be of any shape and size—while complying within the mentioned above constraints—for example not contacting the solar panel and not contacting the solar panel and optionally not contacting any other element within the movement path of the fin.

The shapes of the fins and the support elements may be the same or may differ from each other.

A support element may be a continuous element or may include apertures, may be a grid, a mesh, may include lines or bars that are normal to the axis, and the like.

The solar panels may be fixed solar panels or movable solar panels (such as tracker solar panels).

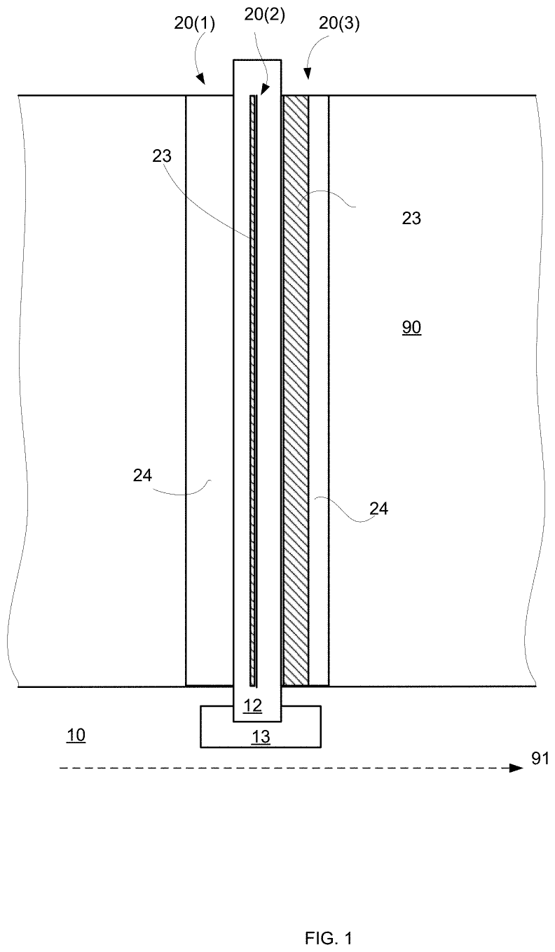

FIG. 1 illustrates an example of a surface cleaning device 10 that cleans one or more solar panels 90 while moving along a longitudinal axis 91 of the one or more solar panels 90.

The surface cleaning device may be any of the surface cleaning devices of illustrated in PCT patent application publication serial number WO2018/008033 international filing date 7 Jul. 2017 and PCT patent application publication serial number WO2019/155375 international filing date 6 Feb. 2019—both PCT patent applications being incorporated herein by reference. For simplicity of explanation—various parts and/or components of the dust cleaning elements were omitted.

Nevertheless—the surface cleaning device 10 may have dust cleaning elements such as 20(1), 20(2) and 20(3) that include fins 24 and support elements 23 that are connected to parts of the fins 24.

The dust cleaning elements 20(1), 20(2) and 20(3) are rotated by an axis (may be a pole) 12 that is rotated by a rotating mechanism 13.

FIG. 1 illustrates three (20(1), 20(2) and 20(3)) out of four dust cleaning elements. The number of dust cleaning elements may differ from four—there may be two, three, fine or more dust cleaning elements.

In FIG. 1 the support elements have a rectangular shape—and contact about half of the fins—but the support elements may have other shapes and may contact larger than half of smaller than half of the fins.

While in FIG. 1 the support elements are connected to one side of the fins-they may be connected to both sides of the fins.

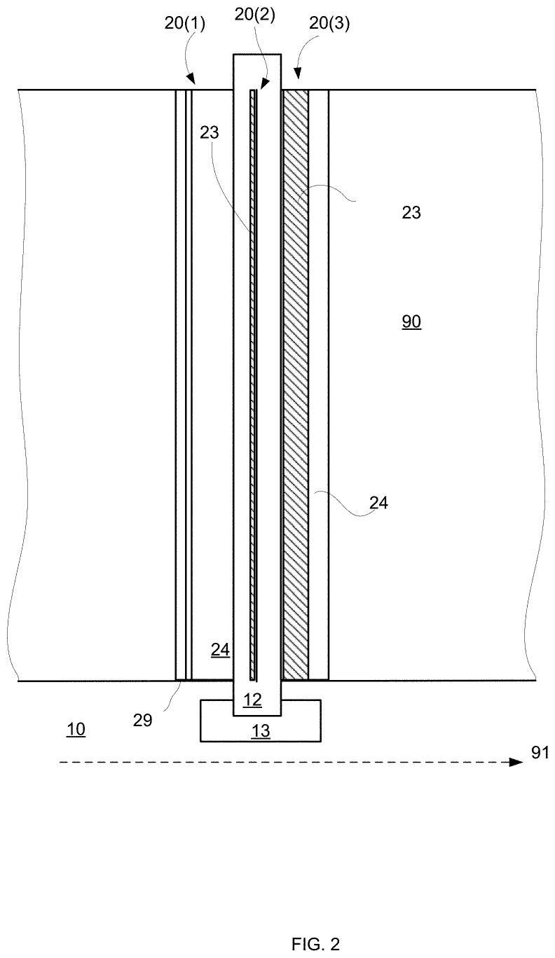

The dust cleaning elements of FIG. 2 differs from the dust cleaning elements of FIG. 1 by showing a motion delay assembly 29 located within the path of the fins. There may be a second dust motion delay assembly located at the opposite side of the axis. The motion delay assembly may be, may include or may be replaced by a shaking member and/or by a condenser. Examples of motion delay assemblies and/or a shaking assembly and/or a condenser are illustrated in PCT patent application publication serial number WO2019/155375 international filing date 6 Feb. 2019—which is incorporated herein by reference.

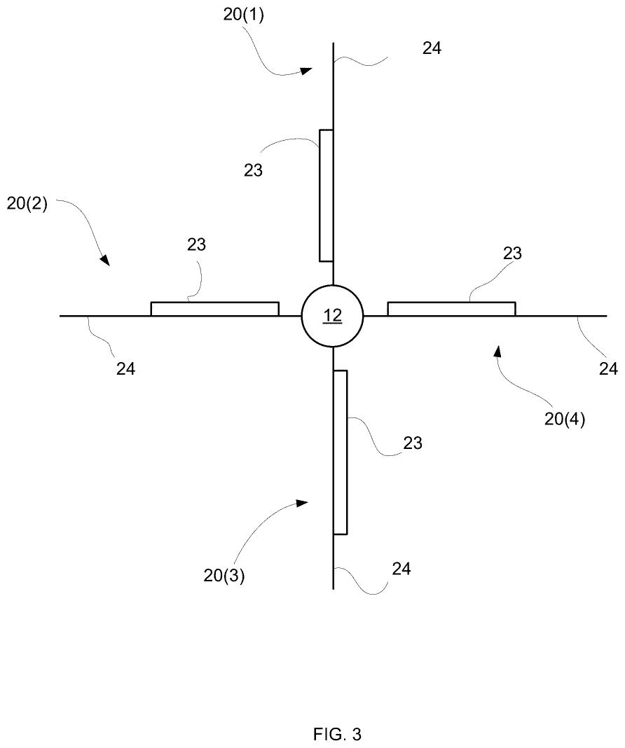

FIG. 3 is a side view of an axis 12 and four dust cleaning elements 20(1), 20(2), 20(3) and 20(4)—each includes a fin 24 and a support element 23. For simplicity of explanation—this figure ignores any interface with a solar panel.

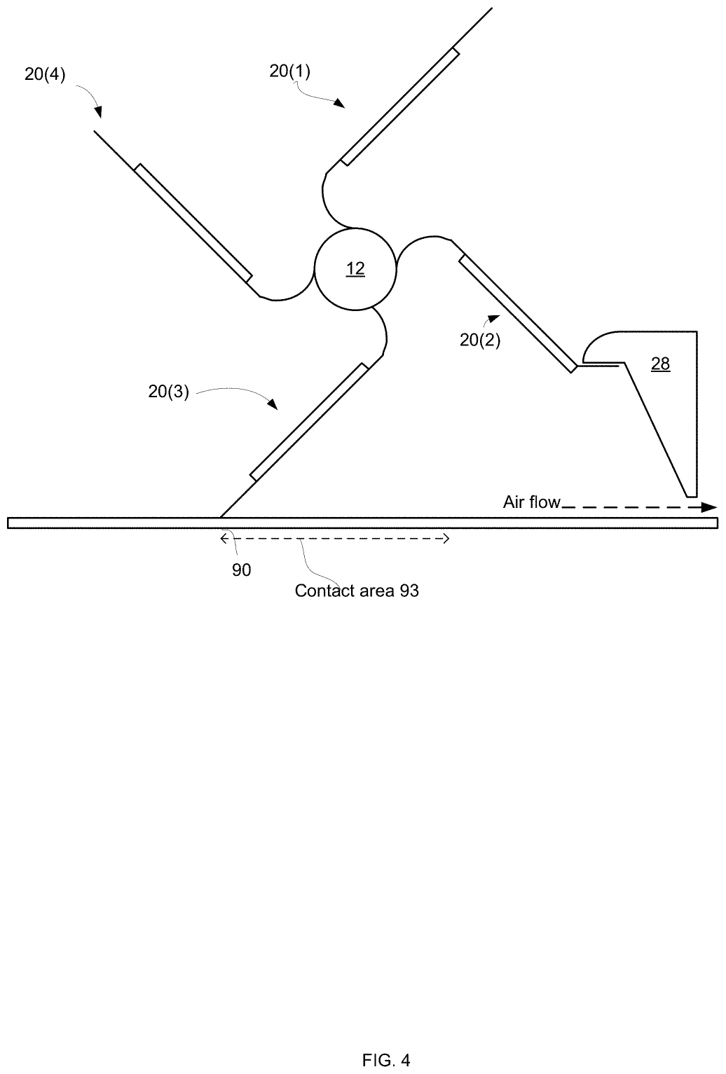

FIG. 4 is a side view of an axis 12 and four dust cleaning elements 20(1), 20(2), 20(3) and 20(4)—each includes a fin 24 and a support element 23. In FIG. 4 the axis is rotated counterclockwise, a third dust cleaning element 20(3) contacts the solar panel and moves to the right, while a second dust cleaning element 20(3) is delated by condenser 28 thereby compress air within a space between the third and second dust cleaning elements and forms a pressurized air flow to pass through (while cleaning dust) a narrow gap between the solar panel and the lower part of the condenser 28. FIG. 4 also illustrates a contact area 93 of the dust cleaning members with the solar panel. Each dust cleaning elements is rotated—causing it to scan the contact area—from a first point of contact with the solar panel till a disconnection from the solar panel.

There may be provided a surface cleaning device that includes dust cleaning elements that may include multiple parts (for example multiple fins or multiple parts of a fin)—the multiple parts can be made of different materials of different properties—for example different tradeoffs between cleaning ability and durability.

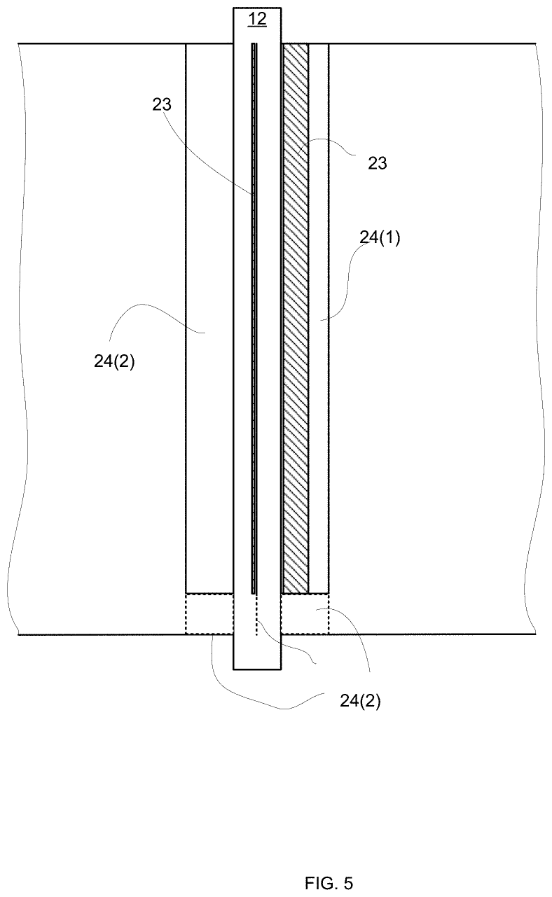

FIGS. 5-7 illustrate dust cleaning elements with a first fin 24(1) that is made from a first material—for example from microfiber. The second fin 24(2) can be made from a second material that has better cleaning properties and is less durable and/or more expensive in relation to the microfiber fin—for example silicon foam.

The second material may be used in located that require better cleaning (for example lower part of solar panels or any other parts in which more dust is aggregated).

There may be any relationship between the size of the first fin and the second fin—to provide desired tradeoff between cleaning efficiency (larger second fin) and cost and durability (smaller second fin).

In FIG. 5 the first fins are with support elements and the second fins are without any support element.

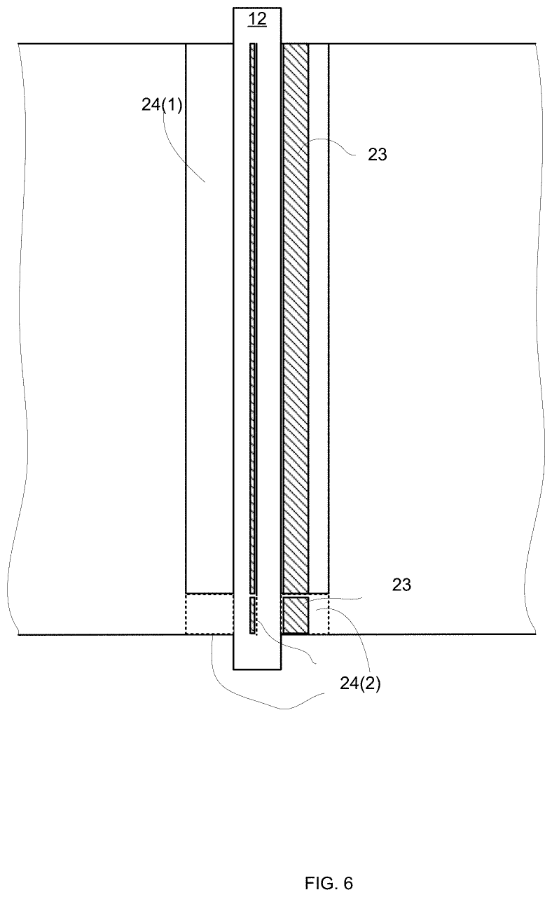

In FIG. 6 the first fins and the second fins are with the support elements.

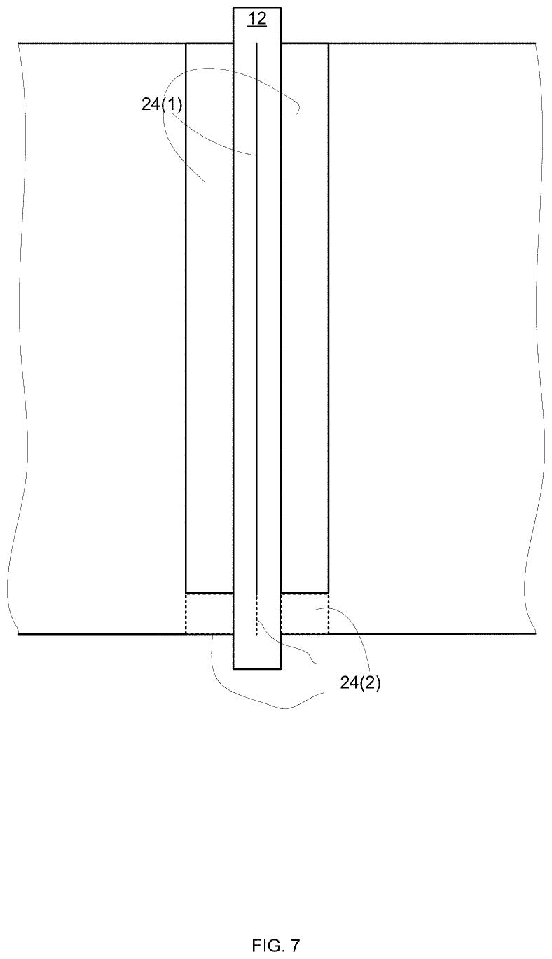

In FIG. 7 the first fins and the second fins are without any the support elements.

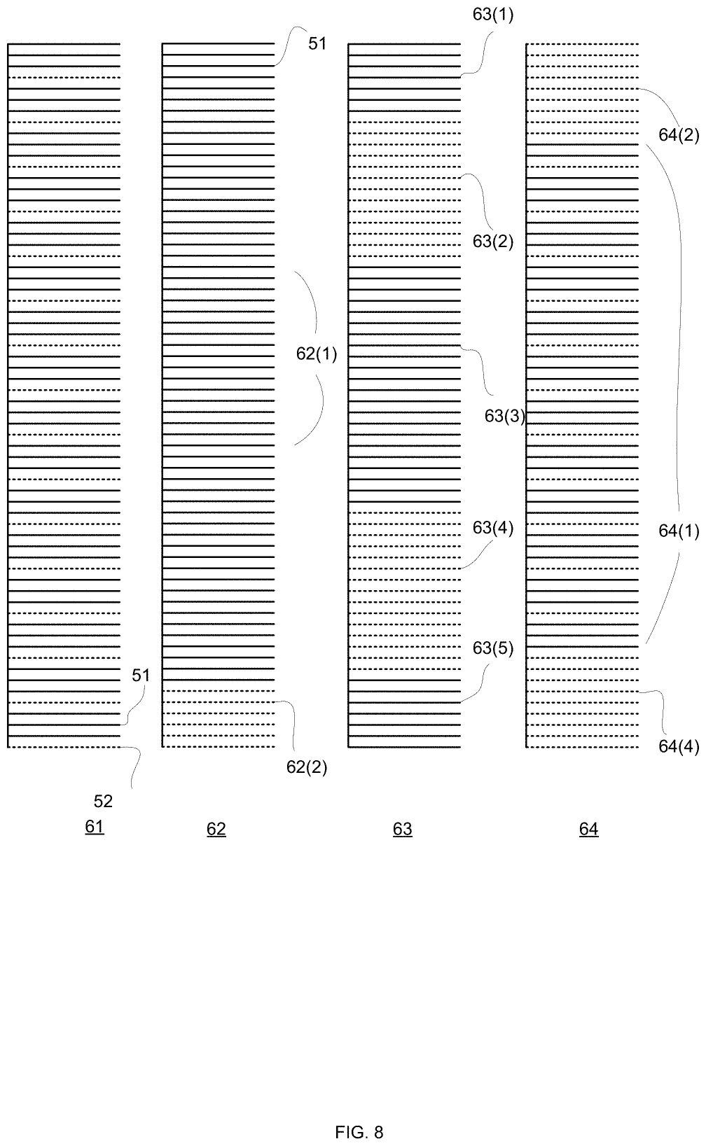

FIG. 8 illustrates different examples (denoted 51, 52, 53 and 54) of multiple fins that are arranged in one or more first regions of the dust cleaning elements and of one or more second regions of the dust cleaning elements.

In FIG. 8 a dashed line represents a second fin 52 while a continuous line represents a first fin 51.

A first example 51 of multiple fins includes a second fin per each three first fins. The ratio may differ from one to three. The first example illustrates a hybrid region—or an overlapping first and second regions.

A second example 52 of the multiple fins includes a single first region 62(1) that includes only first fins and a single second region 62(2) that includes only second fins.

A third example 53 of the multiple fins includes three first regions 63(1), 63(3) and 63(5) that include only first fins and two second regions 63(2) and 63(4) that includes only second fins.

A fourth example 54 of the multiple fins includes two second regions 64(2) and 64(4) that include only first fins and a hybrid region 64(1).

Any number of any region of any type may be provided.

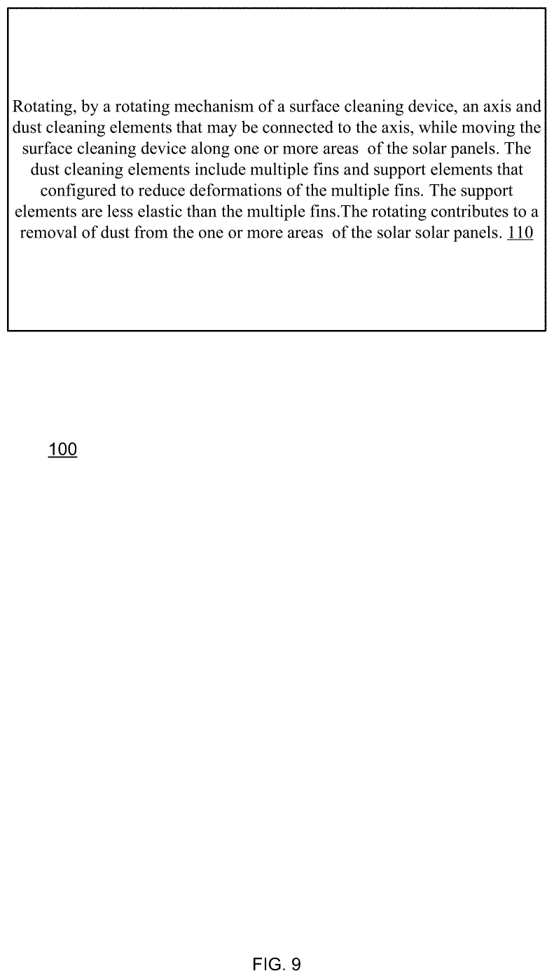

FIG. 9 illustrates an example of method 100 for cleaning solar panels.

Method 100 may include step 110 of rotating, by a rotating mechanism of a surface cleaning device, an axis and dust cleaning elements that may be connected to the axis, while moving the surface cleaning device along one or more areas of the solar panels.

The dust cleaning elements may include multiple fins and support elements that configured to reduce deformations of the multiple fins.

The support elements are less elastic than the multiple fins.

The rotating contributes to a removal of dust from the one or more areas of the solar panels. For example:
a. The rotation may cause the multiple fins to contact the one or more areas and remove dust by contact.
b. The rotation may cause the multiple fins to contact the one or more areas and remove dust by a combination of contact and the generation of one or more airflows.
c. The removal may be assisted by generating stronger air flows by delaying and/or shaking a first fin that propagates away from a contact area of the one or more areas in relation to a second fin that propagates towards the contact area and virtually compress air trapped between the first fin the second fin and the one or more areas.
d. The removal may be assisted by scrappers that precede the contact area.

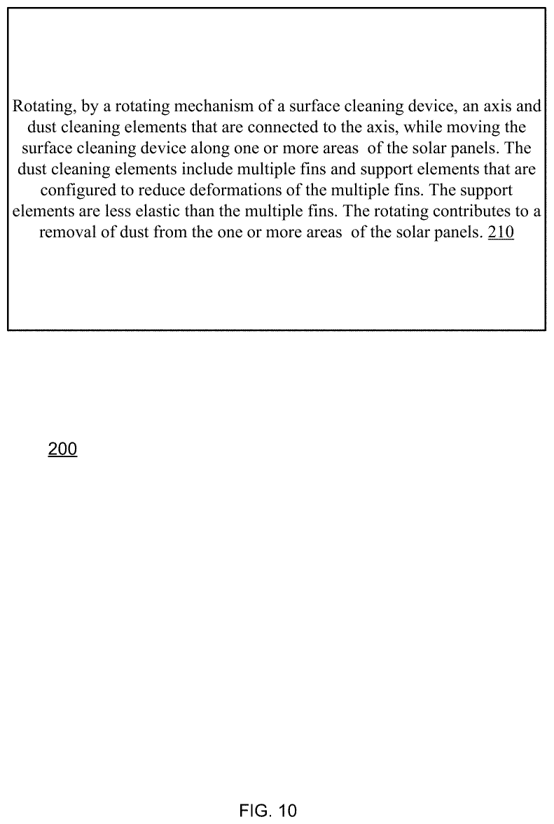

FIG. 10 illustrates an example of method 200 for cleaning solar panels.

Method 200 may include step 210 of rotating, by a rotating mechanism of a surface cleaning device, an axis and dust cleaning elements that are connected to the axis, while moving the surface cleaning device along one or more areas of the solar panels. The dust cleaning elements include multiple fins and support elements that are configured to reduce deformations of the multiple fins. The support elements are less elastic than the multiple fins. The rotating contributes to a removal of dust from the one or more areas of the solar panels.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between blocks are merely illustrative and that alternative embodiments may merge blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A surface cleaning device that comprises:
an axis;
dust cleaning elements that are connected to the axis and comprise multiple fins that comprise (i) one or more first fins of a first durability and a first cleaning capability and (ii) one or more second fins of a second durability and a second cleaning capability, wherein the first durability exceeds the second durability and the second cleaning capability exceeds the first cleaning capability; and
a rotating mechanism for rotating the axis and the multiple fins.

2. The surface cleaning device according to claim 1 wherein the one or more first fins are one or more microfiber fins.

3. The surface cleaning device according to claim 1 wherein the one or more first fins are one or more silicon foam fins.

4. The surface cleaning device according to claim 1 wherein the one or more first fins are located at one or more first regions of the dust cleaning elements, and the one or more second fins are located at one or more second regions of the dust cleaning elements.

5. The surface cleaning device according to claim 4 wherein the one or more first regions and the one or more second regions do not overlap.

6. The surface cleaning device according to claim 4 wherein the one or more first regions and the one or more second regions at least partially overlap.

7. The surface cleaning device according to claim 4 wherein an aggregate size of the one or more first regions exceeds an aggregate size of the one or more second regions.

8. The surface cleaning device according to claim 4 wherein the one or more second regions are located below the one or more first regions.

9. The surface cleaning device according to claim 4 wherein the one or more second regions are located at a bottom of the axis.

10. The surface cleaning device according to claim 1 wherein the one or more first fins are of a first cost per first fin and the one or more second fins are of a second cost per second fin that exceeds the first cost.

11. The surface cleaning device according to claim 1 comprising one or more delay elements positioned in a path of the multiple fins.

12. The surface cleaning device according to claim 11 wherein the dust cleaning elements further comprises support elements that configured to reduce deformations of the multiple fins, wherein the support elements are less elastic than the multiple fins and are positioned outside a reach of the one or more delay elements.

13. The surface cleaning device according to claim 1 comprising one or more shaking elements positioned in a path of the multiple fins.

14. The surface cleaning device according to claim 11 wherein the dust cleaning elements further comprises support elements that configured to reduce deformations of the multiple fins, wherein the support elements are less elastic than the multiple fins and are positioned outside a reach of the one or more shaking elements.

15. The surface cleaning device according to claim 1 wherein the dust cleaning elements further comprises support elements that configured to reduce deformations of the multiple fins, wherein the support elements are less elastic than the multiple fins.

16. The surface cleaning device according to claim 15 wherein the support elements are spaced apart from external edges of the multiple fins.

17. A method for cleaning solar panels, the method comprises:
rotating, by a rotating mechanism of a surface cleaning device, an axis and multiple fins of dust cleaning elements that are connected to the axis, while moving the surface cleaning device along one or more areas of the solar panels; wherein the rotating of multiple fins contributes to a removal of dust from the one or more areas of the solar panels; wherein the multiple fins that comprise (i) one or more first fins of a first durability and a first cleaning capability and (ii) one or more second fins of a second durability and a second cleaning capability, wherein the first durability exceeds the second durability and the second cleaning capability exceeds the first cleaning capability.

18. A surface cleaning device that comprises:
an axis;
dust cleaning elements that are connected to the axis and comprise multiple fins and support elements that configured to reduce deformations of the multiple fins, wherein the support elements are less elastic than the multiple fins; and
a rotating mechanism for rotating the axis and the dust cleaning elements.

19. The surface cleaning device according to claim 17 wherein the support elements are spaced apart from external edges of the multiple fins.

20. A method for cleaning solar panels, the method comprises:
rotating, by a rotating mechanism of a surface cleaning device, an axis and dust cleaning elements that are connected to the axis, while moving the surface cleaning device along one or more areas of the solar panels; wherein the dust cleaning elements comprise multiple fins and support elements that configured to reduce deformations of the multiple fins; wherein the support elements are less elastic than the multiple fins; and wherein the rotating contributes to a removal of dust from the one or more areas of the solar panels.
